(19) United States
(12) Patent Application Publication
(10) Pub. No.: US 2024/0364385 A1
(43) Pub. Date: Oct. 31, 2024

(54) COMMUNICATION APPARATUS AND COMMUNICATION SYSTEM

(71) Applicant: CANON KABUSHIKI KAISHA, Tokyo (JP)

(72) Inventor: YUKI SHOJI, Kanagawa (JP)

(21) Appl. No.: 18/645,064

(22) Filed: Apr. 24, 2024

(30) Foreign Application Priority Data
Apr. 28, 2023 (JP) 2023-074880
Jan. 19, 2024 (JP) 2024-006653

(51) Int. Cl. H04B 5/40

(52) U.S. Cl. CPC H04B 5/40

(57) ABSTRACT

A communication apparatus that communicates with another communication apparatus by coupling using at least one of an electric field and a magnetic field, the communication apparatus includes a coupling conductor configured to transmit or receive a signal by the coupling, a ground conductor configured to have a potential substantially equivalent to a reference voltage of the signal, and a power supply path configured to be connected to the coupling conductor and disposed between the coupling conductor and the ground conductor, wherein the ground conductor is smaller in area than the coupling conductor.

### BACKGROUND

### Field

The present disclosure relates to a communication apparatus configured to transmit signals wirelessly and a communication system.

### Description of the Related Art

In recent years, short range wireless communication systems in which a plurality of communication couplers in close proximity communicates using electromagnetic coupling have been researched and developed. Successful conversion of conventional wired connections using connectors and harnesses for communication between electronic circuit boards and modules into wireless connections leads to reduction in the number of components of connection portions, which is advantageous for simplification of an apparatus manufacturing process. Since an increasing amount of data is transmitted within or between devices in recent years, there is a demand for faster communication in wireless communication systems. Japanese Patent Application Laid-Open No. 2018-113577 discusses a short range wireless communication system in which a transmitter coupler and a receiver coupler are placed to face each other in close proximity and perform data transmission using electromagnetic coupling of a near field generated between the couplers.

### SUMMARY

According to some embodiments, a communication apparatus that communicates with another communication apparatus by coupling using at least one of an electric field and a magnetic field, the communication apparatus includes a coupling conductor configured to transmit or receive a signal by the coupling, a ground conductor configured to have a potential substantially equivalent to a reference voltage of the signal, and a power supply path configured to be connected to the coupling conductor and disposed between the coupling conductor and the ground conductor, wherein the ground conductor is smaller in area than the coupling conductor.

Further features of the present disclosure will become apparent from the following description of exemplary embodiments with reference to the attached drawings.

### BRIEF DESCRIPTION OF THE DRAWINGS

FIG. 1A is a diagram illustrating a configuration of a short range wireless communication system. FIG. 1B is a diagram illustrating reception operations.

FIG. 2A is a diagram illustrating a configuration of couplers according to a conventional technology. FIG. 2B is a diagram illustrating a receiver coupler flipped upside down.

FIG. 3A is a diagram illustrating a transmitter coupler and a receiver coupler according to the conventional technology. FIG. 3B is an enlarged view illustrating the receiver coupler according to the conventional technology. FIG. 3C illustrates a transmission characteristic simulation result of a short range communication system.

FIG. 4 is a diagram illustrating a configuration of a receiver coupler according to a first exemplary embodiment.

FIG. 5 is a diagram illustrating a comparison of transmission characteristics of the receiver coupler according to the first exemplary embodiment and the receiver coupler according to the conventional technology.

FIGS. 6A to 6C are diagrams illustrating shapes of a coupler according to a second exemplary embodiment with various lengths.

FIG. 7 is a diagram illustrating a relationship between the lengths and the transmission characteristic of the coupler according to the second exemplary embodiment.

FIG. 8 is a diagram illustrating a configuration of a coupler and a receiver circuit according to a third exemplary embodiment.

FIG. 9 is a diagram illustrating another configuration of the coupler and the receiver circuit according to the third exemplary embodiment.

### DESCRIPTION OF THE EMBODIMENTS

### Verification of Issues in Short Range Wireless Communication Systems According to Conventional Technologies

Issues in short range wireless communication systems will be described further below prior to describing exemplary embodiments of the present disclosure.

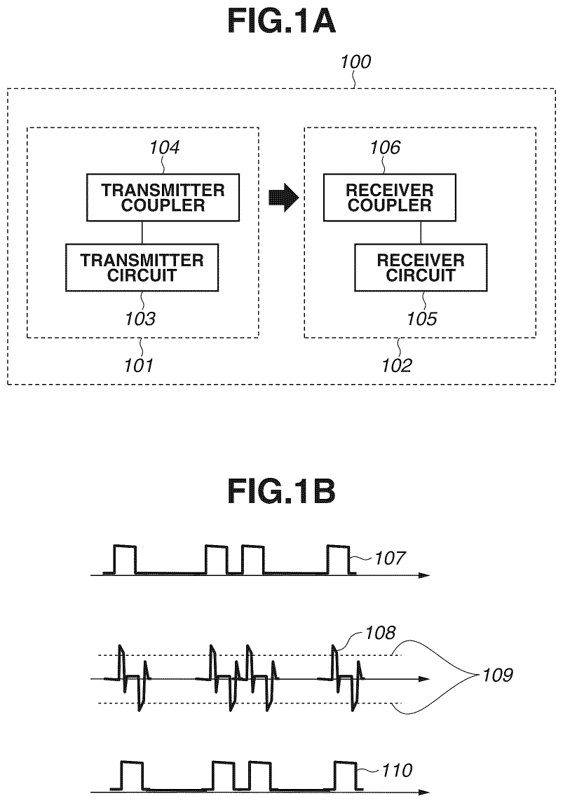

FIGS. 1A and 1B are diagrams illustrating a signal transmission method in a short range wireless communication system. In FIG. 1A, a communication system 100 includes a transmitter device 101 and a receiver device 102. The transmitter device 101 includes a transmitter circuit 103 and a transmitter coupler 104, and the receiver device 102 includes a receiver circuit 105 and a receiver coupler 106. The transmitter coupler 104 and the receiver coupler 106 perform communication using electromagnetic coupling.

The electromagnetic coupling includes both electric coupling and magnetic coupling. Specifically, wireless communication between the transmitter coupler 104 and the receiver coupler 106 may be performed using electric coupling, magnetic coupling, or electric coupling and magnetic coupling. A description will be mainly given of cases where the transmitter coupler 104 functions as a transmission line coupler, the receiver coupler 106 functions as an electric field coupler, and communication is performed using electric coupling according to exemplary embodiments.

Next, reception operations of the receiver coupler 106 and the receiver circuit 105 will be described below with reference to FIG. 1B. In a case where a digital signal 107 is output from the transmitter circuit 103 and input to the transmitter coupler 104, a received signal 108 (a differential signal of the digital signal 107) is obtained from the receiver coupler 106. A process of converting the received signal 108 into a digital signal 110 based on a threshold 109 of a comparator (not illustrated) or an amplifier (not illustrated) of the receiver circuit 105 is performed. While a transmitted signal in FIG. 1B indicates a binary baseband signal (digital signal), a modulated signal may be used.

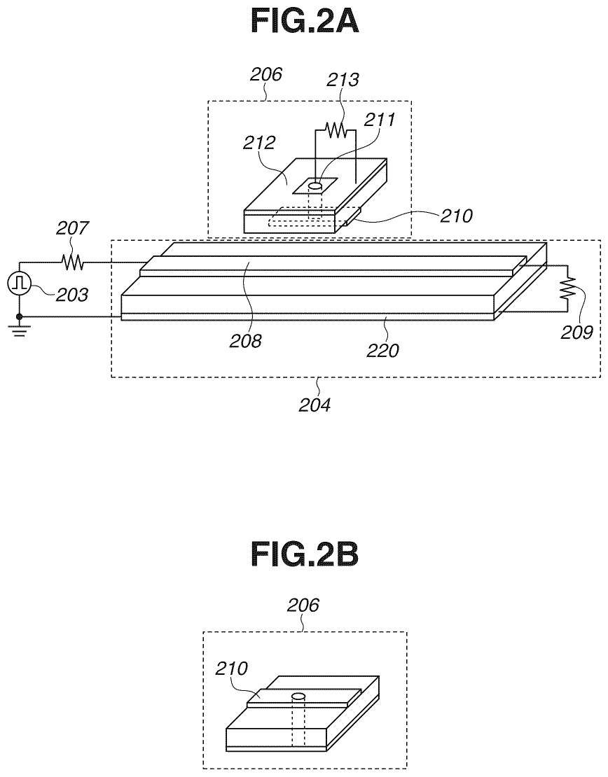

FIGS. 2A and 2B are diagrams illustrating a configuration of a transmitter coupler 204 and a receiver coupler 206 according to a conventional technology. FIG. 2B is a diagram illustrating the receiver coupler 206 in FIG. 2A flipped upside down (partially omitted). In FIG. 2A, the transmitter coupler 204 includes a conductor 208, a ground 220, and a termination resistor 209. The conductor 208 has a long and thin shape extending along a predetermined direction. The ground 220 generates a reference potential. A digital signal generated by a transmitter circuit 203 is applied to an end of the conductor 208 via a power supply line, such as a coaxial cable. A resistor 207 between the transmitter circuit 203 and the conductor 208 represents an output impedance of the transmitter circuit 203. The other end of the conductor 208 is connected to the ground 220 via the termination resistor 209. A ground of the transmitter circuit 203 and the ground 220 are connected together via a ground portion of the power supply line. A potential of the ground 220 is substantially equivalent to a reference voltage of the signal transmitted through the conductor 208. The termination resistor 209 is set to 50 Ω (ohms) but is not limited to 50 Ω and may be a different resistance value. By matching a characteristic impedance of a microstrip line including the conductor 208 and the ground 220, which generates the reference potential, with the value of the termination resistor 209, the transmitter coupler 204 operates as a transmission line coupler with favorable characteristics.

The receiver coupler 206 includes a conductor 210, a ground plane 212, a power supply path 211, and a receiver coupler termination resistor 213. The ground plane 212 generates a reference potential, and the power supply path 211 is a conductor through which received signals received by the conductor 210 pass. The conductor 210 receives electromagnetic field energy transmitted from the transmitter coupler 204. The receiver coupler termination resistor 213 is disposed between the power supply path 211 for received signals and the ground plane 212. The receiver coupler termination resistor 213 may be implemented in the comparator or the amplifier in the receiver circuit 105. In this case, via a power supply line such as a coaxial cable, the receiver coupler termination resistor 213 is connected to the power supply path 211 and an input of the receiver circuit, and the plane of the ground plane 212 and a ground of the receiver circuit is connected to each other.

While FIGS. 2A and 2B illustrate a configuration that transmits single-ended signals, a configuration that transmits differential signals may be employed.

For example, in a case where there is no noise or static electricity in the surroundings, a potential of the ground plane 212 is 0 V (volts). A signal voltage generated by the receiver coupler termination resistor 213 uses the potential of the ground plane 212 as a reference potential. Specifically, the signal voltage generated by the receiver coupler termination resistor 213 has a waveform with positive and negative voltages with 0 V as the reference voltage. Driving the comparator (not illustrated) or the amplifier (not illustrated) of the receiver circuit with positive and negative power supplies causes a waveform with positive and negative voltages with 0 V as the reference voltage to be input to the comparator or the amplifier, which leads to the process of conversion into the digital signal 110.

In this case, the reference potential of the ground plane 212 is substantially equivalent to the potential of the ground of the digital signal converted by the receiver circuit 105.

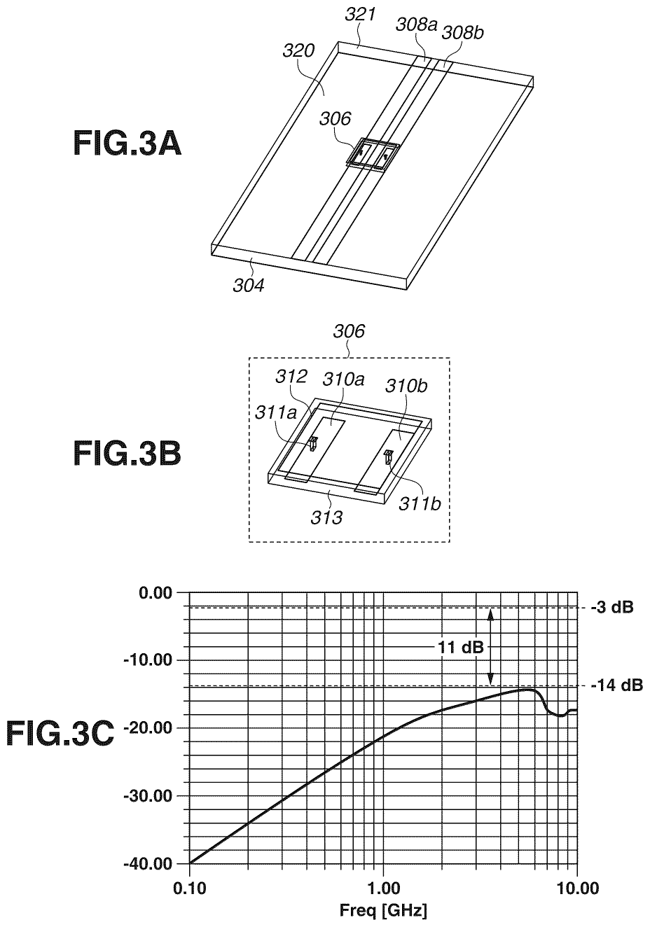

FIGS. 3A to 3C illustrate a simulation model and a simulation result (transmission characteristic) of a short range communication system according to the conventional technology. A configuration that transmits differential signals is illustrated in FIGS. 3A to 3C.

FIG. 3A illustrates a transmitter coupler 320 and a receiver coupler 306. The transmitter coupler 320 includes differential transmission lines 308a and 308b formed on a flame retardant 4 (FR4) substrate 321. The FR4 substrate 321 has a multi-layer structure and includes a ground plane 304 on a layer different from a layer on which the differential transmission lines 308a and 308b are disposed.

The receiver coupler 306 is disposed in close proximity to the differential transmission lines 308a and 308b. FIG. 3B is an enlarged view illustrating the receiver coupler 306 illustrated in FIG. 3A. The receiver coupler 306 includes coupling conductors 310a and 310b, a ground plane 312, and power supply paths 311a and 311b for received signals. The foregoing conductor structure is formed on a FR4 substrate 313. While not illustrated, the transmitter coupler 320 is connected to a transmitter circuit, and the receiver coupler 306 is connected to a receiver circuit. An output impedance Rtx is defined as an output impedance of the transmitter circuit, a resistance value Rrx is defined as a resistance value of a termination resistor of the receiver coupler 306, and a resistance value Rt is defined as a resistance value of a termination resistor of the transmitter coupler 320. In the simulation, Rtx=Rrx=Rt=50 Ω. As to the differential transmission lines 308a and 308b, a termination resistor is disposed between each of the differential transmission lines 308a and 308b and the ground plane 312.

FIG. 3C illustrates a simulation result of a transmission characteristic from the transmitter coupler 320 to the receiver coupler 306 in the simulation model illustrated in FIG. 3A. A horizontal axis represents frequencies of signals transmitted through the differential transmission lines 308a and 308b using a logarithmic scale. A vertical axis represents the ratio between P₁ and P₂ in dB (10 log(P₂/P₁)), where P₁ is a power of a signal input to the differential transmission lines 308a and 308b and P₂ is a power consumed by a receiver coupler termination resistor.

A maximum transmission characteristic that is obtained in a case where ideal electric coupling is achieved between the transmitter coupler 320 and the receiver coupler 306 is −3 dB (decibels). However, a maximum value of the transmission characteristic in FIG. 3C is about −14 dB. Thus, there is a degradation of about 11 dB in transmission characteristics from the ideal state. The degradation in transmission characteristics causes a decrease in signal quality, and an issue arises where high-speed data transmission cannot be performed.

A first exemplary embodiment of the present disclosure focuses on a size and shape of the ground plane 312 of the receiver coupler 306 in FIG. 3 as factors that cause the deterioration in transmission characteristics described above. The conventional technology does not clarify a relationship between a size and shape and a transmission characteristic of a conductor corresponding to the ground plane 312. Thus, the present disclosure is directed to clarifying a relationship between a size and shape and a transmission characteristic of the ground plane 312 and providing a size and shape of the ground plane 312 for improving the transmission characteristic.

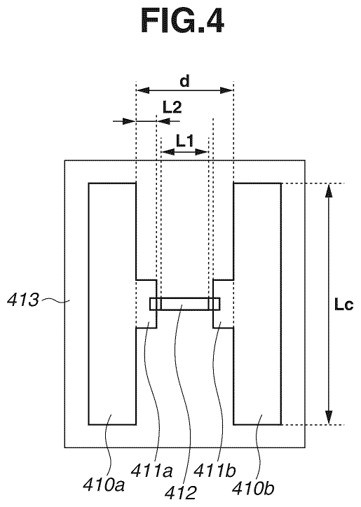

FIG. 4 illustrates a shape of a receiver coupler according to the present exemplary embodiment. The receiver coupler illustrated in FIG. 4 includes coupling conductors 410a and 410b, a ground plane 412, and power supply paths 411a and 411b for received signals. The foregoing conductor structure is formed on a FR4 substrate 413. A length L1 is defined as a length of the ground plane 412. A length L2 is defined as a length of each of the power supply paths 411a and 411b for received signals. A distance d is defined as a distance between the closest linear sections of the coupling conductors 410a and 410b to each other. Furthermore, a length Lc is defined as a length of each of the coupling conductors 410a and 410b along a long side direction.

The receiver coupler according to the present exemplary embodiment is configured in such a manner that the ground plane 412 is smaller in area than the coupling conductors 410a and 410b, and the power supply paths 411a and 411b for received signals are formed in a planar manner on the same layer as the coupling conductors 410a and 410b. With this configuration, effects of the ground plane 412 on the coupling conductors 410a and 410b are reduced.

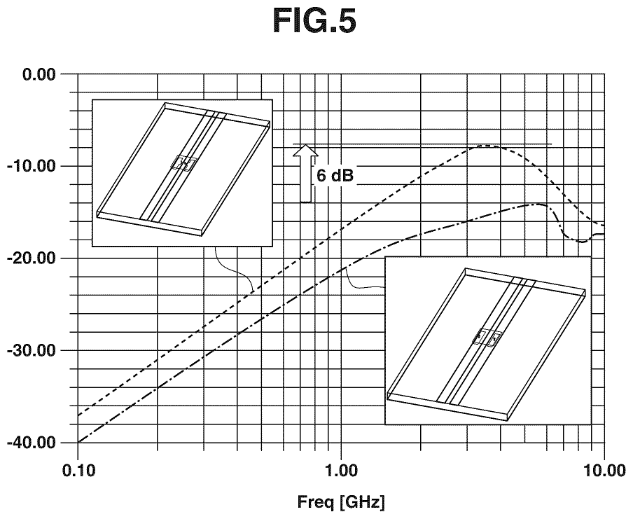

FIG. 5 illustrates a comparison of transmission characteristics of the receiver coupler according to the present exemplary embodiment and the receiver coupler according to the conventional technology. In an electromagnetic field analysis of transmission characteristics in FIG. 5, parameters are set in such a manner that L1=2.0 mm (millimeters), L2=0.8 mm, d=4.0 mm, and Lc=10 mm. The length Lc of each of the coupling conductors 410a and 410b along the long side direction is the same as a length of each of the coupling conductors 310a and 310b along a long side direction in FIG. 3. It can be seen from FIG. 5 that there is an improvement of about 6 dB in transmission characteristics of the receiver coupler according to the present exemplary embodiment compared to the receiver coupler according to the conventional technology.

As can be seen from the analysis result, reducing the size of the ground conductor to be smaller than the size of the coupling conductor leads to an improvement in the transmission characteristic of the receiver coupler.

A description will be given of a configuration according to a second exemplary embodiment of the present disclosure that improves a cutoff frequency of a transmission characteristic by adjusting the length L1 of the ground plane 412 and the length L2 of each of the power supply paths 411a and 411b for received signals. A cutoff frequency fc of a transmission characteristic will be described below.

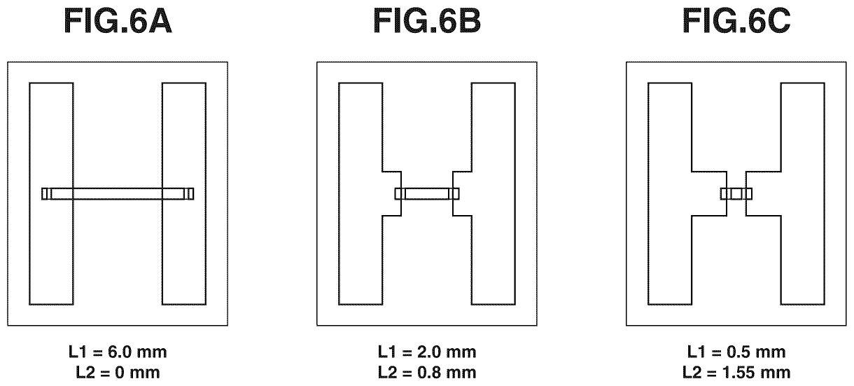

An impedance Zc is defined as an impedance of a coupling capacitance formed between the conductor 208 of the transmitter coupler 204 and the conductor 210 of the receiver coupler 206 that are electrically coupled in FIG. 2. The impedance Zc is represented as 1/ωC and decreases with increasing frequency. In a case where the frequency increases and the following relationship Zc<<Rtx=Rrx=Rt is satisfied, the value of the transmission characteristic on the vertical axis reaches a peak value, and this frequency is defined as the cutoff frequency fc. Higher cutoff frequencies indicate that transmission can be performed at higher frequencies, and high-speed communication is achieved. FIGS. 6A to 6C are diagrams illustrating shapes of the coupler according to the second exemplary embodiment with lengths L1 and L2 having various lengths.

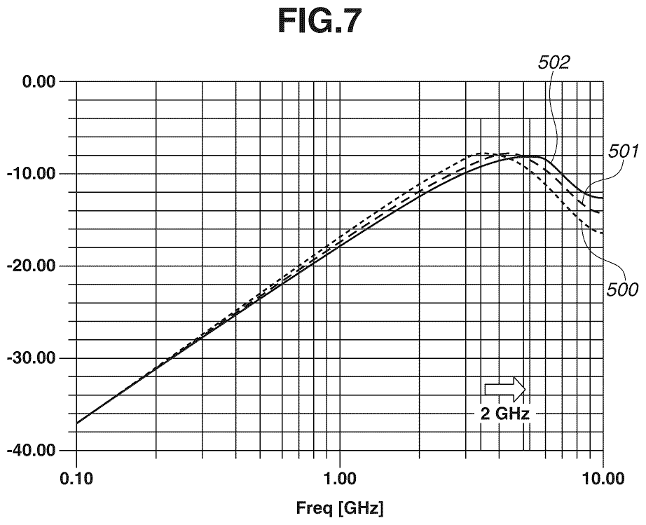

FIG. 7 is a diagram illustrating transmission characteristics in cases where the receiver couplers illustrated in FIGS. 6A, 6B, and 6C are disposed. A plotted line 500 in the graph represents a transmission characteristic of the receiver coupler illustrated in FIG. 6A. A plotted line 501 represents a transmission characteristic of the receiver coupler illustrated in FIG. 6B. A plotted line 502 represents a transmission characteristic of the receiver coupler illustrated in FIG. 6C. It can be seen from FIG. 7 that the cutoff frequency fc can be changed to a higher frequency by reducing the length L1 while increasing the length L2. A comparison of the plotted lines 500 and 502 indicates a change of the cutoff frequency fc to a frequency that is higher by about 2 GHz (gigahertz). This improvement in the cutoff frequency fc indicates that an improvement of 2 Gbps (gigabits per second) in data rate can be expected.

While the power supply paths and the ground plane are illustrated as being connected together in FIGS. 4 and 6, this merely illustrates power supply ports on the simulation model, and in an actual configuration, a resistor or a power supply line is connected.

While the transmitter coupler and the receiver coupler are described as a transmission path coupler and an electric field coupler, respectively, and sizes and shapes of the ground plane of the receiver coupler are described above according to the first and second exemplary embodiments, the above-described configuration may also be applied in reverse or also applicable in both the transmitter coupler and the receiver coupler. Specifically, in a case where the transmitter coupler and the receiver coupler are both electric field couplers, similar effects are produced with respect to sizes and shapes of the ground planes of the transmitter coupler and the receiver coupler.

While, in the first and second exemplary embodiments, the transmitter coupler and the receiver coupler are formed on the FR4 rigid substrate in copper patterns, materials of the substrate are not limited to FR4 and may be Teflon® or ceramics, or a flexible substrate made of polyimide may be used.

In the first and second exemplary embodiments, as for a positional relationship between the transmitter coupler or the receiver coupler and the transmitter circuit or the receiver circuit, the transmitter circuit or the receiver circuit and the transmitter coupler or the receiver coupler may be formed on the same substrate and connected together via power supply lines using patterns or may be disposed at separated locations and connected together via power supply lines, such as coaxial cables.

While, in the first and second exemplary embodiments, the pair of conductors having a substantially rectangular shape are illustrated and described as a shape of the receiver coupler, the shape of the receiver coupler is not limited to the above-described shape and may be a circular, elliptical, or polygonal shape.

In the first and second exemplary embodiments, as for values of the reference potential of the ground plane 212, the reference potential of the ground plane 212 is not limited to 0 V and may be any potential as long as the reference potential is substantially constant. Specifically, if necessary, a direct current bias voltage may be applied to the ground plane 212. Applying the direct current bias voltage causes a signal voltage generated by the receiver coupler termination resistor 213 to be a voltage centered around the direct current bias voltage. This leads to a waveform without a negative voltage, which allows utilization of a comparator or an amplifier that operates on a single power supply.

In the above-described configurations according to the first and second exemplary embodiments, the ground conductor is disposed in the receiver coupler, and the area of the ground conductor is reduced to a size smaller than that of the coupling conductor. In a configuration according to a third exemplary embodiment described below, a ground conductor is disposed only in a receiver circuit without disposing a ground conductor in a receiver coupler.

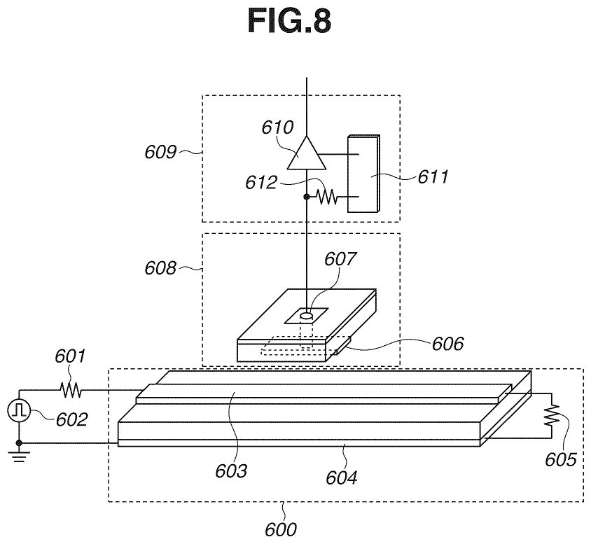

FIG. 8 is a diagram illustrating an example of a configuration of couplers and a receiver circuit according to the present exemplary embodiment. In FIG. 8, a transmitter coupler 600 includes a conductor 603, a ground 604, and a termination resistor 605. The conductor 603 has a long and thin shape extending along a predetermined direction, and the ground 604 generates a reference potential. A digital signal generated by a transmitter circuit 602 is applied to an end of the conductor 603 via a power supply line, such as a coaxial cable. A resistor 601 between the transmitter circuit 602 and the conductor 603 represents an output impedance of the transmitter circuit 602. The other end of the conductor 603 is connected to the ground 604 via the termination resistor 605. A ground of the transmitter circuit 602 and the ground 604 are connected together via a ground portion of the power supply line. A potential of the ground 604 is substantially equivalent to a reference potential of the signal transmitted through the conductor 603. The termination resistor 605 may be 50 Ω but is not limited to 50 Ω and may be a different resistance value. Matching a characteristic impedance of a microstrip line including the conductor 603 and the ground 604, which generates the reference potential, with the value of the termination resistor 605 causes the transmitter coupler 600 to operate as a transmission line coupler with favorable characteristics.

A receiver coupler 608 without a ground includes a coupling conductor 606 and a power supply path 607. The power supply path 607 is a conductor that extracts a received signal. A receiver circuit 609 includes a comparator or amplifier 610, a reference ground 611 of the receiver circuit 609, and a termination resistor 612 for reception. The coupling conductor 606 receives electromagnetic field energy transmitted from the transmitter coupler 600 by electromagnetic coupling. The termination resistor 612 for reception may be implemented in the comparator or amplifier 610 in the receiver circuit 609. The reference ground 611 of the receiver circuit 609 performs functions equivalent to the ground plane 212 in FIG. 2.

Specifically, as can be seen from the simulation results of the first and second exemplary embodiments, reducing the area of the reference ground 611 of the receiver circuit 609 to a size smaller than the size of the coupling conductor 606 leads to an improvement in the transmission characteristic of the receiver coupler 608.

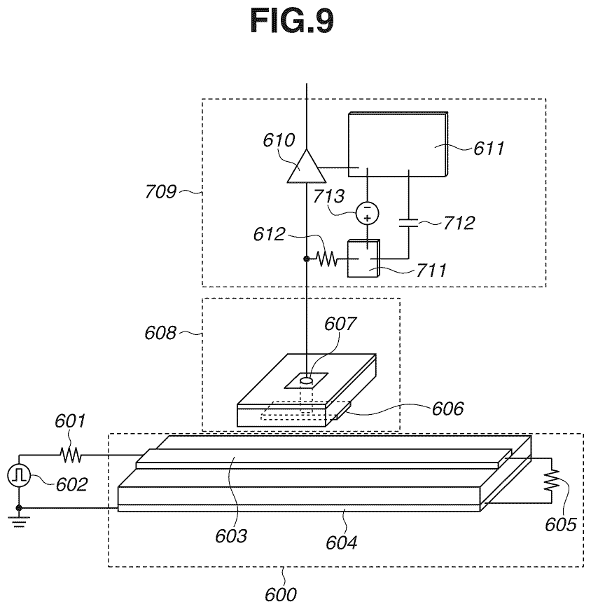

FIG. 9 is a diagram illustrating another example of a configuration of a receiver circuit. A receiver circuit 709 has the configuration of the receiver circuit 609 illustrated in FIG. 8 and further includes a conductor 711 having a substantially constant potential, a capacitor 712, and a direct current bias voltage source 713. The capacitor 712 and the direct current bias voltage source 713 are connected between the conductor 711 and the reference ground 611 of the receiver circuit 709. The capacitor 712 functions as a decoupling capacitor and has a characteristic of passing only high-frequency noise to the reference ground 611.

The potential difference between the conductor 711 having a substantially constant potential and the reference ground 611 of the receiver circuit 709 is equal to a voltage that the direct current bias voltage source 713 outputs. The capacitor 712 is connected between the conductor 711 and the reference ground 611 of the receiver circuit 709, and an impedance between the two conductors is significantly small in high-frequency noise. Thus, the potential difference between the conductor 711 and the reference ground 611 is substantially constant in direct current. Thus, the conductor 711 performs functions equivalent to the ground plane 212 illustrated in FIG. 2 and the reference ground 611 of the receiver circuit 609 illustrated in FIG. 8. Specifically, as can be seen from the simulation results of the first and second exemplary embodiments, reducing the area of the conductor 711 to a size smaller than the size of the coupling conductor 606 leads to an improvement in the transmission characteristic of the receiver coupler 608.

The first, second, and third exemplary embodiments are mere examples of implementation of the present disclosure, and the technical scope of the present disclosure should not be interpreted narrowly based on the first, second, and third exemplary embodiments. Specifically, the present disclosure can be implemented in various forms without departing from the technical concept or major features of the present disclosure.

The disclosure of the present disclosure includes the following communication apparatus.

### Item 1

A communication apparatus that communicates with another communication apparatus by coupling using at least one of an electric field and a magnetic field, the communication apparatus includes a coupling conductor configured to transmit or receive a signal by the coupling, a ground conductor configured to have a potential substantially equivalent to a reference voltage of the signal, and a power supply path configured to be connected to the coupling conductor and disposed between the coupling conductor and the ground conductor, wherein the ground conductor is smaller in area than the coupling conductor.

### Item 2

The communication apparatus according to item 1, wherein the ground conductor is smaller in area than the power supply path.

### Item 3

The communication apparatus according to item 1 or 2, wherein the coupling conductor includes a pair of substantially rectangular conductors.

### Item 4

The communication apparatus according to item 3, wherein a signal input to the another communication apparatus or the communication apparatus is a differential signal.

### Item 5

The communication apparatus according to item 4, wherein the differential signal is a binary baseband signal or a modulated signal.

### Item 6

The communication apparatus according to any items 1 to 5, wherein the coupling conductor is formed in a pattern with a rigid substrate or a flexible substrate.

### Item 7

The communication apparatus according to item 6, wherein the coupling conductor and the power supply path are formed on a same layer of the rigid substrate or the flexible substrate.

### Item 8

The communication apparatus according to item 6, wherein the coupling conductor, the power supply path, and a transmitter circuit configured to generate the signal to transmit the signal or a receiver circuit configured to process the received signal are formed on the same rigid substrate or the same flexible substrate.

### Item 9

The communication apparatus according to any one of items 1 to 8, further includes a power supply line configured to be connected to a transmitter circuit configured to generate the signal to transmit the signal or a receiver circuit configured to process the received signal.

### Item 10

The communication apparatus according to item 9, wherein the power supply line includes a coaxial cable.

### Item 11

A communication system includes a transmission apparatus including a first coupling conductor configured to transmit a signal by coupling using at least one of an electric field and a magnetic field, a first ground conductor configured to have a potential substantially equivalent to a reference voltage of the signal, and a first power supply path configured to connect the first coupling conductor and the first ground conductor, and a reception apparatus including a second coupling conductor configured to receive the signal by the coupling, a second ground conductor configured to have a potential substantially equivalent to the reference voltage of the signal, and a second power supply path configured to connect the second coupling conductor and the second ground conductor, wherein the first ground conductor is smaller in area than the first coupling conductor, or the second ground conductor is smaller in area than the second coupling conductor.

### Item 12

A communication apparatus that communicates with another communication apparatus by coupling using at least one of an electric field and a magnetic field, the communication apparatus includes a coupling conductor configured to receive a signal by the coupling, a receiver circuit configured to receive input of the signal received by the coupling conductor, a first conductor configured to be disposed in the receiver circuit and have a substantially constant potential, and a power supply path configured to be connected to the coupling conductor and disposed between the coupling conductor and the first conductor, wherein the first conductor is smaller in area than the coupling conductor.

### Item 13

The communication apparatus according to item 12, wherein the receiver circuit includes a comparator or an amplifier.

### Item 14

The communication apparatus according to item 12 or 13, wherein the first conductor is a ground conductor of the receiver circuit.

### Item 15

The communication apparatus according to any one of items 12 to 14, wherein the receiver circuit includes a second conductor different from the first conductor, and the second conductor is a ground conductor of the receiver circuit.

### Item 16

The communication apparatus according to item 15, wherein the receiver circuit includes a bias voltage source and a capacitor connected between the first conductor and the second conductor.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2023-074880, filed Apr. 28, 2023, and No. 2024-006653, filed Jan. 19, 2024, which are hereby incorporated by reference herein in their entirety.

What is claimed is:

1. A communication apparatus that communicates with another communication apparatus by coupling using at least one of an electric field and a magnetic field, the communication apparatus comprising:
a coupling conductor configured to transmit or receive a signal by the coupling;
a ground conductor configured to have a potential substantially equivalent to a reference voltage of the signal; and
a power supply path configured to be connected to the coupling conductor and disposed between the coupling conductor and the ground conductor,
wherein the ground conductor is smaller in area than the coupling conductor.

2. The communication apparatus according to claim 1, wherein the ground conductor is smaller in area than the power supply path.

3. The communication apparatus according to claim 1, wherein the coupling conductor includes a pair of substantially rectangular conductors.

4. The communication apparatus according to claim 3, wherein a signal input to the another communication apparatus or the communication apparatus is a differential signal.

5. The communication apparatus according to claim 4, wherein the differential signal is a binary baseband signal or a modulated signal.

6. The communication apparatus according to claim 1, wherein the coupling conductor is formed in a pattern with a rigid substrate or a flexible substrate.

7. The communication apparatus according to claim 6, wherein the coupling conductor and the power supply path are formed on a same layer of the rigid substrate or the flexible substrate.

8. The communication apparatus according to claim 6, wherein the coupling conductor, the power supply path, and a transmitter circuit configured to generate the signal to transmit the signal or a receiver circuit configured to process the received signal are formed on the same rigid substrate or the same flexible substrate.

9. The communication apparatus according to claim 1, further comprising a power supply line configured to be connected to a transmitter circuit configured to generate the signal to transmit the signal or a receiver circuit configured to process the received signal.

10. The communication apparatus according to claim 9, wherein the power supply line includes a coaxial cable.

11. A communication system comprising:
a transmission apparatus including:
a first coupling conductor configured to transmit a signal by coupling using at least one of an electric field and a magnetic field,
a first ground conductor configured to have a potential substantially equivalent to a reference voltage of the signal, and
a first power supply path configured to connect the first coupling conductor and the first ground conductor; and
a reception apparatus including:
a second coupling conductor configured to receive the signal by the coupling,
a second ground conductor configured to have a potential substantially equivalent to the reference voltage of the signal, and
a second power supply path configured to connect the second coupling conductor and the second ground conductor,
wherein the first ground conductor is smaller in area than the first coupling conductor, or the second ground conductor is smaller in area than the second coupling conductor.

12. A communication apparatus that communicates with another communication apparatus by coupling using at least one of an electric field and a magnetic field, the communication apparatus comprising:
a coupling conductor configured to receive a signal by the coupling;
a receiver circuit configured to receive input of the signal received by the coupling conductor;
a first conductor configured to be disposed in the receiver circuit and have a substantially constant potential; and
a power supply path configured to be connected to the coupling conductor and disposed between the coupling conductor and the first conductor,
wherein the first conductor is smaller in area than the coupling conductor.

13. The communication apparatus according to claim 12, wherein the receiver circuit includes a comparator or an amplifier.

14. The communication apparatus according to claim 12, wherein the first conductor is a ground conductor of the receiver circuit.

15. The communication apparatus according to claim 12, wherein the receiver circuit includes a second conductor different from the first conductor, and the second conductor is a ground conductor of the receiver circuit.

16. The communication apparatus according to claim 15, wherein the receiver circuit includes a bias voltage source and a capacitor connected between the first conductor and the second conductor.
